(19) United States
(12) Patent Application Publication
(10) Pub. No.: US 2018/0250537 A1
(43) Pub. Date: Sep. 6, 2018

(54) Facemask with Pleated Filter and Continuous Strap

(71) Applicant: Waterford Mask Systems Inc., Deerfield Beach, FL (US)

(72) Inventor: Steve Waterford, Deerfield Beach, FL (US)

(21) Appl. No.: 15/911,109

(22) Filed: Mar. 3, 2018

Related U.S. Application Data
(60) Provisional application No. 62/467,081, filed on Mar. 3, 2017.

(51) Int. Cl. A62B 23/02; A62B 9/06; A62B 9/04; A62B 18/08

(52) U.S. Cl. CPC A62B 23/025; A62B 9/06; A62B 18/10; A62B 18/08; A62B 9/04

(57) ABSTRACT

A facemask assembly can include airflow vents that can be configured to direct inward airflow to strike an interior air filter. In some embodiments airflow strikes the air filter at an oblique angle. In some embodiments, the filter insert assembly is pleated. In some embodiments, the air filter contains biocidal elements. Some internal filter designs enhance the capture of exhaled moisture which activates silver ions in the filter material creating a biocidal environment. Some facemasks have a filter permanently sealed internally with a filter material than can withstand boiling and autoclaving temperatures so the entire mask system—without disassembly—become sterilisable. Some facemasks have snap-in zones that can accommodate a wide variety of strap(s), and can accommodate a single, continuous band. This band can be tension adjusted by adding twists and then being snapped back into the snap-in zones.

### CROSS-REFERENCE TO RELATED APPLICATIONS

This application also claims priority benefits from U.S. Provisional Patent Application No. 62/467,081 filed Mar. 3, 2017 entitled “Facemask with Pleated Filter and Continuous Strap”. The '081 application is hereby incorporated by reference in its entirety.

### FIELD OF THE INVENTION

The present invention concerns facemasks, and in particular facemasks to protect against airborne particulates and pathogens.

Masks are often used as a form of protection against airborne particulates and pathogens, including bacteria and viruses. Facemasks are typically worn over the mouth and nose of the wearer, and can incorporate a form of eye protection. Masks can be used in environments with high levels of airborne particulates and/or allergens where the wearer wishes to not inhale said particulate. To effectively reduce a wearer's exposure to airborne substances, a respiratory protection device needs to fit well and effectively filter out said substances.

Preventing inhalation and contact with airborne pathogens and environmental allergens is not only important in environments that require high levels of air purity, such as hospitals, but also in homes of people suffering from allergies. Additionally, wearers suffering from respiratory infections can benefit from the filter capture of pathogens and allergens when out in public.

Current masks can be attach to the wearer's head by means of tie straps, elastic straps headbands, and/or nonadjustable holes cut into the mask designed to fit around the wearer's ear. Alternatively, masks can be fastened using elastic straps around the head or ears. Rectangular cross-sectional elastics are often used in one-size-fits-all nonadjustable masks. These masks are often uncomfortable as they can stretch and/or pinch the skin around the ears and back of the head.

In addition, conventional masks are often required to be disposable as the strapping material tends to capture skin excretions as well as airborne particulates and pathogens and is difficult to clean.

Furthermore, conventional masks generally do not include a biocide-coated insert. They instead rely on airborne particulate, pathogen and droplet-trapping fabrics and physical barriers for protection. Those that do incorporate biocide-coated inserts often require rupturing an envelope to become operable. This rupturing requirement introduces problems including wearers forgetting or being unable to rupture the envelope, or prematurely rupturing the envelope.

In addition, in current mask designs, wearer's exhalations are directed out through the front of the mask. Airborne pathogens not entrapped by the mask are effectively sent directly towards those in front of the wearer. Another problem is conventional masks often provide a poor seal between the mask and the face due to the force of exhalations and the use of non-adjustable elastic fittings that do not provide enough force to keep the mask fitting snuggly.

Disposable filtering facepiece respirators are commonly used in environments where greater protection is required than that provided by surgical masks. Yet, these respirators also suffer from inherent flaws including but not limited to:
(1) ties or elastic strap connections that connect along the sides of the respirators near the upper nose seal area and thus, when sufficiently tied or tensioned to seal against the face, simultaneously pull the mask away from the upper nose seal area which can prevent-a complete seal;
(2) wearers have the option of improperly fitting the mask to their face by insufficiently pinching inward the conformable strip in a generic nose bridge area, this also permits the wearer's exhalations to flow up into their eyes and can fog glasses and eye-protection systems;
(3) little or no upward lift is provided by either ties or elastic straps for a proper seal in the chin area; and
(4) restricted breathability due to the accumulation of water from wearer exhalations that can clog the mask filter.

What is needed is an adjustable mask that inherently fits snuggly and comfortably. What is also needed is a mask with an internal biocidal filter designed to capture exhaled H₂O to activate silver biocidal ions, yet also enables-venting of heated, CO₂-laden exhalations.

### SUMMARY OF THE INVENTION

The embodiments described below and shown in the various drawings overcome many known shortcomings of conventional facemasks. Such shortcomings include a lack of adjustability and perpetuation of restricted and/or misdirected air-flow.

In some embodiments, the masks provide, among other things, a continuous strap system. In some embodiments, the strap is built directly into the mask itself. In some of these embodiments, the strap is integrated directly into the nose bridge of the mask, generating forces with components parallel and perpendicular to the plane of the face. In some embodiments, adjustability of the mask can be enhanced by allowing the strap to interact with a nose bridge clip, such that the mask can be adjusted and molded to more closely fit the face of a wearer. In some embodiments, the mask can be configured to pull upward beneath the chin as well as towards the plane of the face to provide a tight fit.

In some embodiments, the facemask can comprise a lower air intake. In certain embodiments, this intake is located on the lower front section of a mask. In some embodiments, the air intake directs airflow at a non-right angle to the plane of a filter contained within the mask.

In some embodiments, an air filter is internal to the mask. In certain embodiments, the filter is replaceable. In at least some embodiments, the filter is sealed within the mask structure. In some embodiments, the air filters have biocidal components.

In some embodiments, there are no front-facing openings on the mask. In some of these embodiments, the facemask can comprise channels that direct exhaled air backwards, in a direction toward or behind the plane of a wearer's face. In some embodiments, this venting occurs from multiple sides of a mask simultaneously. In at least some of these embodiments, vent systems are symmetrically placed about an axis in the plane of the mask. In certain embodiments, the exhaled air is directed towards the cheeks, neck and/or ears of a wearer.

In some embodiments, air is blocked by a solid front-facing construct that restricts direct access to an internal filter from frontal air flow. In some embodiments, masks can contain diaphragm check valves designed to direct exhaled air away from a filter element. In at least some of these embodiments, the exhaled air flows through channels backwards and/or sideways from the mask.

In some embodiments, a facemask system can comprise a nose clip and/or elastic components to complete a continuous strap. Some embodiments of a facemask system feature through holes through which a strap can be mounted. In some embodiments, the strap can clip or snap into a mask.

In some embodiments, the mask can have a flexible center region. In some embodiments of the mask system, flexible openings are provided. In some of these embodiments, the openings are configured to receive at least one resonating diaphragm.

In some embodiments, openings in a facemask can be circular, oblate, and/or polygonal. In some embodiments, openings can form to receive various attachments. In certain embodiments, a facemask can comprise extrusions along an interior rim and/or on a top or bottom section of the mask.

In certain embodiments, a facemask can comprise an eye shield. In some of these embodiments, the eye shield is transparent. In some embodiments, an eye shield can comprise at least one extrusion inserted through a pair of through holes. In certain embodiments, an eye shield can be secured at the nose area of the mask. In some embodiments, the eye shield can also rest against the wearers forehead and/or cheekbones.

Some embodiments of the facemask occur at least in part in the following configuration:
(a) at least one air vent for bidirectional flow of air being inhaled and exhaled by the wearer, the at least one airflow intake capable of directing inward airflow to strike an interior air filter at an oblique angle;
(b) a head mounting pad having a single pull to tension the facemask against the wearer's face;
(c) a continuous strap positionable under the chin of the wearer;
(d) a nose bridge clip positionable by the wearer before and during the tensioning of the strap.

In some embodiments, a nose bridge clip provides materials suitable for creation of “compression zones”, wherein these zones can have areas of differing flexibility to conform to a face.

In some preferred embodiments, a mask has snap-in receivers. Some embodiments of snap-in receivers are given in the figures presented herein, however these are not meant to be the only disclosed locations or embodiments of snap-in receivers.

In embodiments having snap-in receivers, the receivers are often (but not exclusively) meant to receive strap(s) for the mask assembly. In some embodiments, the receivers are designed to accommodate a single, continuous strap. In some preferred embodiments, a mask has two snap-in receivers, one in the nose area, and one in the proximity of a wear's chin. The receivers need not be similarly designed to one another. For instance, one receiver can resemble a slot in the mask itself, while the other receiver can resemble a hook. In some embodiments, snap-in receivers can accommodate other mask attachments, such as an eye shield.

In some embodiments, the continuous strap is elastic, and can be adjusted by twisting the strap behind the head of a wearer. Such a design provides numerous advantages over the prior art, such as fewer breakable components, removing the need for clasps or buckles, increased ability to adjust applications of force by the mask to conform to any face, and ease of mask removal.

### BRIEF DESCRIPTION OF THE DRAWINGS

FIG. 1 is a side view of a mask assembly having a single, continuous strap assembly.

FIG. 2 is a rear perspective view of the mask assembly of FIG. 1 wherein the strap is being adjusted.

FIG. 3 is a rear perspective view of the mask assembly of FIG. 1 wherein the strap has been adjusted.

FIG. 4 is a side exploded perspective view of a pleated filter insert assembly having a pleated filter, a front frame, and a rear frame.

FIG. 5 is a side perspective view of the filter insert assembly from FIG. 4 assembled.

FIG. 6 is a front view of the mask assembly of FIG. 1 with the continuous strap removed for clarity.

FIG. 7 is a side view of the mask assembly of FIG. 1 indicating bi-directional airflow.

### DETAILED DESCRIPTION OF THE PREFERRED EMBODIMENT(S)

### Continuous Strap Assembly

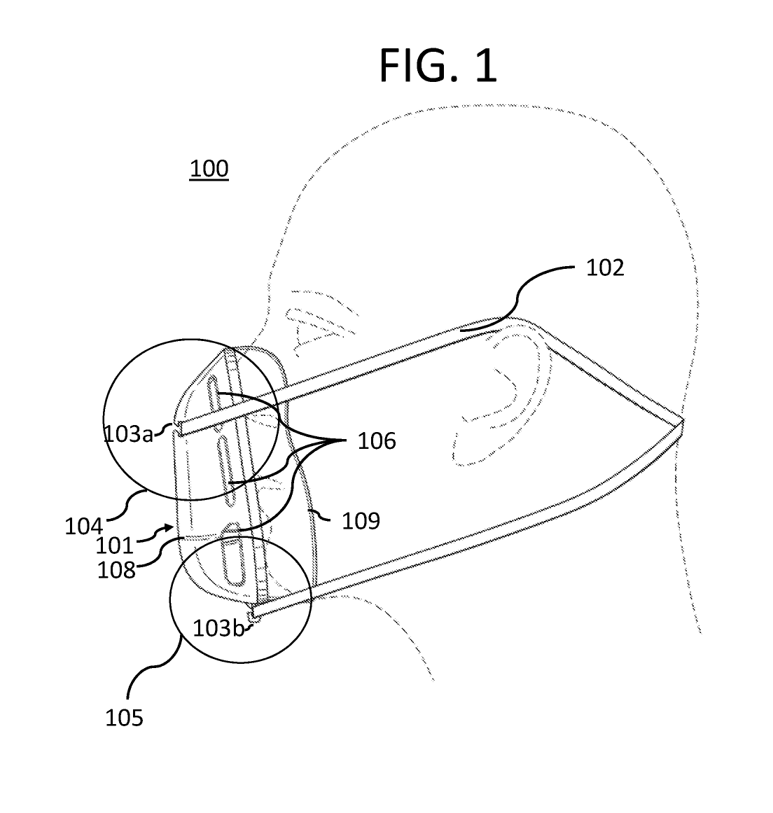

FIG. 1 is a side view of mask assembly 100 having continuous strap 102. Strap 102 can be made of, among other things, various straps, cords, tubing, and/or O-ring stock. In most, if not all, embodiments, strap 102 is elastic.

In the illustrated embodiment, snap-in receivers 103a and 103b are present in nasal area 104 of mask 101 and beneath chin area 105. In FIG. 1, two different snap-in receivers 103a and 103b are shown. Snap-in receiver 103b, located beneath the chin, resembles a hook receiving continuous strap 102. Snap-in receiver 103a, located in the nasal section, shows a valley defined by two extrusions that receives the upper part of continuous strap 102. In addition to hooks and extrusions, snap-in receivers 103 can resemble, among other things, voids, divets, sets of ridges, and other suitable moldings of mask 101 that can accommodate straps.

Snap-in receivers have many advantages, such as allowing a wearer to replace strap 102 on the fly. For example, if strap 102 were to break and a wearer did not have access to a proper replacement strap, the wearer could utilize a wide variety of suitable materials such as his or her own shoelace for an immediate field repair. This feature could be life-saving should such an immediate field repair be necessary in an infectious and/or hazardous air environment.

In at least some embodiments, vents 106 are configured to vent exhaled CO₂ and H₂O-laden air sideways and/or backwards towards a wearer's face and neck. In some embodiments, vents 106 do not allow exhaled air to be channeled downward. In some embodiments, vents have lips configured to direct the flow of exhaled air.

In some embodiments, mask 101 contains facial skirt 109. In some embodiments, facial skirt 109 has elastic properties. In at least some embodiments, facial skirt 109 can be made of a soft silicone, materials that conform to a wearer's face and/or materials capable of creating an airtight seal.

In at least some embodiments, front section 108 of mask 101 is constructed of a hard plastic. In other embodiments, other materials, including but not limited to rubber, silicone, metals, other thin plastics and/or composite materials can be used to construct front section 108. In certain embodiments, front section 108 has unrestricted venting that is large enough to improve the speech clarity of a wearer when compared to traditional masks.

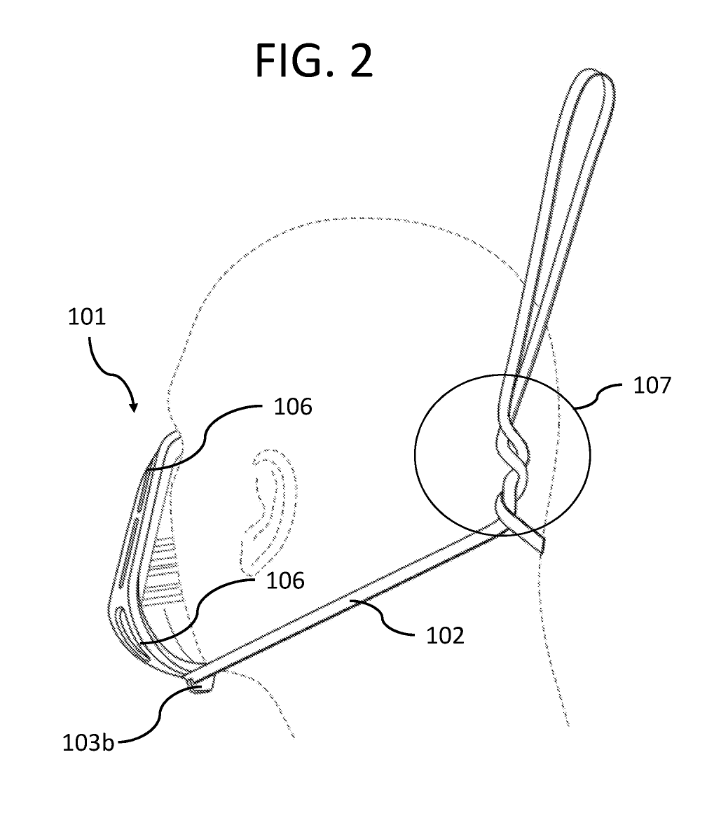

FIG. 2 is a rear perspective view of mask assembly 100 of FIG. 1 showing strap 102 being adjusted. In some single strap embodiments, such as the one shown in FIG. 2, strap 102 can be twisted to tighten mask assembly 100 on the face of a wearer.

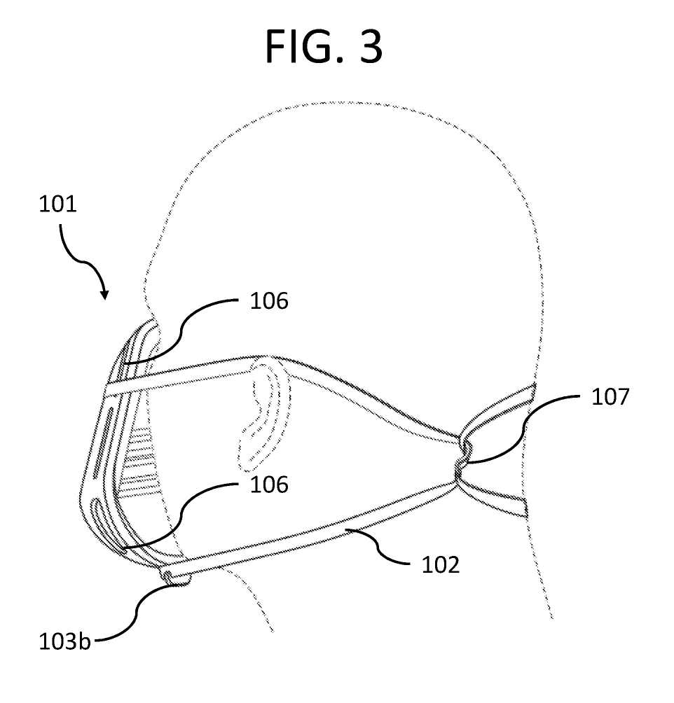

Twisting strap 102 in area 107 helps conform mask 101 to the face of the wearer as it increases the seal created by the mask. Twisting strap 102 in the way illustrated in FIG. 2, also raises strap 102 above the top ear joint of the wear; thus reducing pressure on the ear and increasing the wear's comfort. As evident in FIG. 3, twisting strap 102 can change the angle of applied pressure between strap 102 crossing over the ear and strap 102 crossing behind the head.

In some embodiments, once enough twists have been established to create a secure seal, strap 102 can be re-inserted into snap-in receivers 103a and 103b. In at least some embodiments, no further adjustment to strap 102 need to be made to use and remove mask assembly 100. This is in sharp contrast to traditional elastomeric masks which require the release of at least the two lower straps in order to remove the mask. In addition, in traditional elastomeric masks the previous tension must often be re-established upon remounting the mask.

Another advantage of single strap embodiments is their self-adjusting nature which does not require the manipulation of multiple straps to conform to the head of a wearer. Many embodiments having a single, twistable strap 102 do not require buckles, tri-glides, plastic strap adjusters, cord-locks and/or other adjustable elements to change the tensioning of strap 102. Individual strap adjustment is also not necessary to center the mask on the face; strap 102 slides within the snap-in receivers 103 so there is little, if any, side-pull generated by them. In addition, single continuous strap 102 is inherently easy to clean; especially as compared to traditional adjusters such as buckles, tri-glides, plastic strap adjusters and cord-locks.

FIG. 3 is a rear perspective view of mask assembly 100 of FIG. 1 according to some embodiments. Strap 102 is shown re-inserted into snap-in receivers 103a (not shown) and 103b. In at least some embodiments, strap 102 self-aligns within snap-in receivers 103a and 103b and crosses behind the head to produce a snug, self-centering fit.

In some embodiments (not shown) mask assembly 100 can utilize two straps, a top strap configured to slide into the snap-in receiver 103a which allows the top strap to slide back and forth to balance the position of any clips and/or buckles (not shown) and a bottom strap configured to slide in snap-in receiver 103b. In some embodiments, snap-in receivers allow the straps to be easily removed. In some embodiments, clips and/or buckles can be used to help stabilize the upper and/or lower straps. Various embodiments of straps can be configured to fit with a mask design given the placement of various snap voids or receivers. In some embodiments, open-ended straps can be tied behind the ears or the head or secured and adjusted

### Pleated Filter

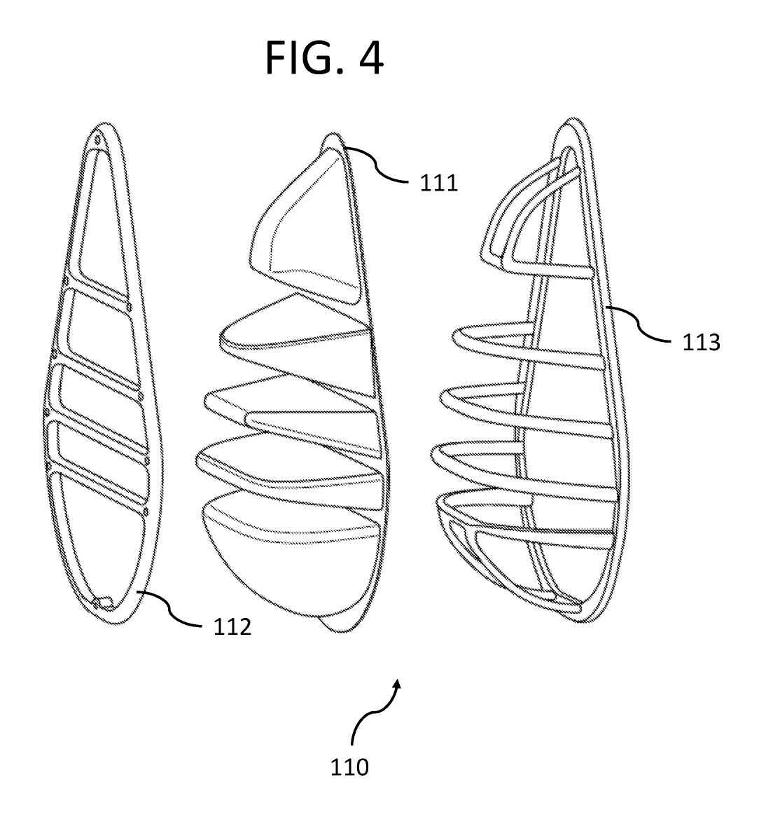

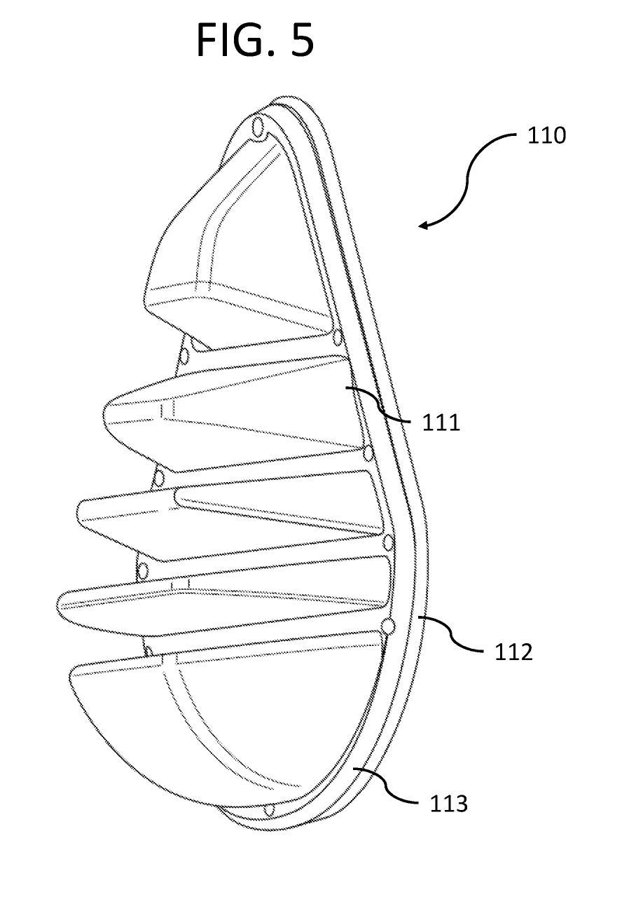

FIG. 4 is an exploded perspective view of pleated filter insert assembly 110. Pleated filter insert assembly 110 can comprises pleated filter 111, front frame 112, and rear frame 113. In the shown embodiment, rear frame 113 is configured to receive front frame 112, with pleated filter 111 sandwiched between. FIG. 5 is a side perspective view of filter insert assembly 110 from FIG. 4 fully assembled.

As seen in FIG. 4, front frame 112, and rear frame 113 can contain cross members with those in rear frame 113 being elevated and curved to cause pleated filter 111 to assume a curved, pleated shape. In at least some embodiments, this pleated shape increases the breathable surface area as well as increases the angularity of the oblique angle of attack experienced by inhaled particulates and/or pathogens.

In some embodiments pleated filter 111 has a single active layer. In other embodiments pleated filter 111 has multiple active layers. In certain embodiments, the active material contains silver which acts as a biocidal element. In some embodiments, the active material is silver nanoparticles. In other or the same embodiments pleated filter 111 can be optimized for the capture of non-infectious particles such as dust or air pollution particulates.

In some embodiments, filter insert assembly 110 is permanently affixed to mask 101 (see FIG. 1).

In some embodiments, pleated filter insert frame can be curved and/or S-shaped to capture airborne particles and provide biocidal protection from airborne pathogens. The “s-shaped” structure of pleated filter insert assembly 110 positions pleated filter 111 close to the nose and mouth. In some embodiments using materials that need moisture to provide protection biocidal protection, such silver, this “s-shaped” ensures that material receives adequate moisture.

In some embodiments, filter insert assembly 110 can be flat and/or flattened. Flat designs allow for smaller packaging.

In some embodiments, filter insert assembly 110 is held in mask 101 by an elastic ridge and/or a stopper ridge. In some embodiments, filter insert assembly 110 is permanently mounted within mask 100. In certain embodiments, stopper extrusions keep filter insert assembly 110 pressed back into skirt 109. In some embodiments, stopper extrusions can keep filter insert assembly 110 from contacting the front section of the mask.

In at least some embodiments, a pleated filter contains at least 10% more surface area than a flat filter. In at least some embodiments, a pleated filter contains at least 20% more surface area than a flat filter. In at least some embodiments, a pleated filter contains at least 30% more surface area than a flat filter. In at least some embodiments, a pleated filter contains at least 40% more surface area than a flat filter. In at least some embodiments, a pleated filter contains at least 50% more surface area than a flat filter. In at least some embodiments, a pleated filter contains at least 60% more surface area than a flat filter. In at least some embodiments, a pleated filter contains at least 70% more surface area than a flat filter. In at least some embodiments, a pleated filter contains at least 80% more surface area than a flat filter. In at least some embodiments, a pleated filter contains at least 90% more surface area than a flat filter. In at least some embodiments, a pleated filter contains at least 100% more surface area than a flat filter.

In at least some embodiments, a pleated filter contains at least 10% more surface area than a dual canister filter. In at least some embodiments, a pleated filter contains at least 20% more surface area than a flat filter. In at least some embodiments, a pleated filter contains at least 30% more surface area than a dual canister filter. In at least some embodiments, a pleated filter contains at least 40% more surface area than a dual canister filter. In at least some embodiments, a pleated filter contains at least 50% more surface area than a dual canister filter. In at least some embodiments, a pleated filter contains at least 60% more surface area than a dual canister filter. In at least some embodiments, a pleated filter contains at least 70% more surface area than a dual canister filter. In at least some embodiments, a pleated filter contains at least 80% more surface area than a dual canister filter. In at least some embodiments, a pleated filter contains at least 90% more surface area than a dual canister filter. In at least some embodiments, a pleated filter contains at least 100% more surface area than a dual canister filter.

Mask Configured for Bi-Directional Airflow Directed Towards the Back and/or Sides of a Wearer

Existing elastomeric half-face masks require one-way check valves, generally elastic diaphragms mounted directly in front of the mouth, to enable exhalations to vent. Inhalations and exhalations are each mono-directional. Exhaled air above the exhaust vent is thus trapped above it, which prevents nasal breathing primarily due to the build-up of CO₂. In addition, particulates and pathogens captured by the filter material migrate through that filter material with every inhalation as the exhalation, which would push them outwards, goes out instead of thru the diaphragm vent.

In some embodiments, facemask assembly 100 is configured to reduce, if not completely prevent, forward facing air inhalations and exhalations. In some embodiments, vents 106 can be channeled to create oblique airflow patterns over a filter insert. In embodiments having pleated filter insert(s), these channels can be configured to coincide with filter pleats.

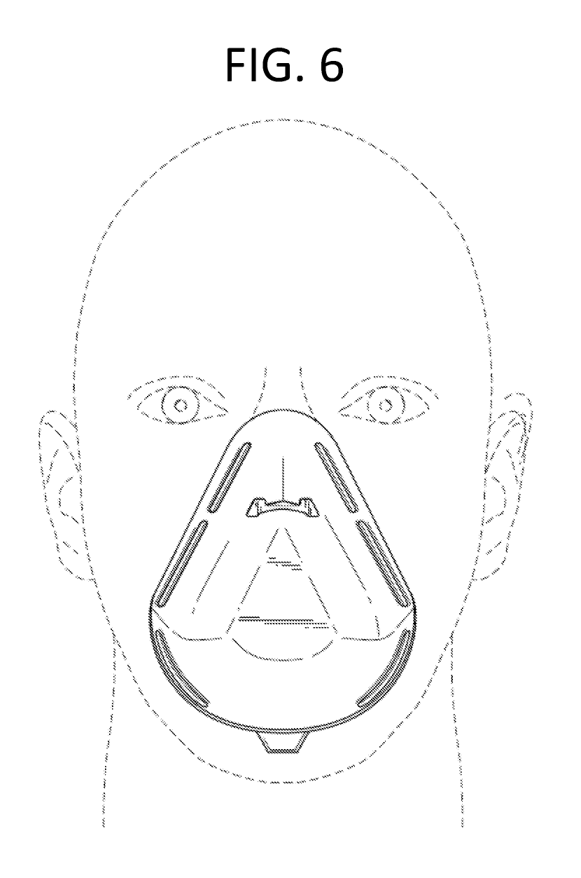

FIG. 6 is a front view of mask assembly 100 with continuous strap 102 removed for clarity. In FIG. 6, there is no direct access to the internal filter (such as filter assembly 110 from FIGS. 4 and 5) from the frontal flow of air on to the mask surface, and the exhaled air is vented sideways and/or backwards relative to the plane of a wearer's face through vents 106. In some preferred embodiments, vents are arranged symmetrically around mask 101.

In some embodiments, vents 106 are configured to allow the escape of exhaled heat, moisture and CO₂. In certain embodiments, vents 106 are sufficiently large enough such that a wearer can be heard more clearly. In some embodiments vents 106 force exhaled air and CO₂ off to the sides of a wearer's face. In some embodiments, this can be accomplished by placing vents 106 near the upper most sides of mask 101 where exhaled air tends to migrate. The sideways and backwards venting of exhalations is of particular importance when the wearer of a mask is ill to protect those in front of the wearer. In some embodiments, vents can be configured to aid in reducing frontal contact of inhaled particles onto the filter.

In some embodiments, vent(s) 106 placed above the nostrils of the wearer can support improved nasal breathability over conventional masks and respirators. In some embodiments vent(s) 106 placed above the nostrils of the wearer can accentuate the oblique angle air flow that supports greater capture of air-borne elements within the surface of the filter.

In some embodiments, the bi-directional airflow design of the presently disclosed mask, reduces the likelihood of particulates and pathogens migrating through the filter. In at least some embodiments, air cannot be trapped within the mask as the uppermost vents are above the wearers' nostrils.

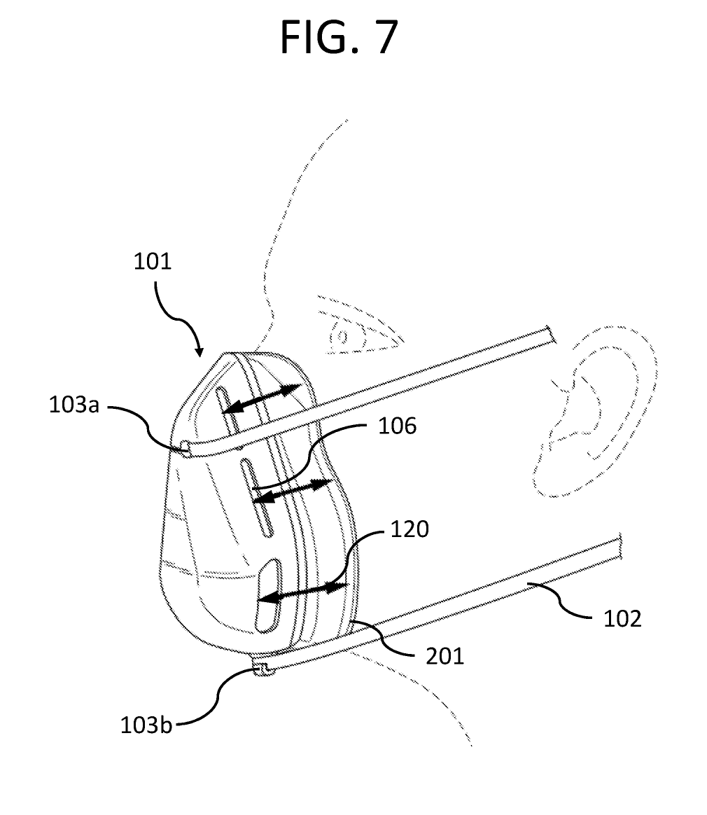

FIG. 7 is a side view of the side of mask assembly 100, showing the air vents 106, along with the inward and rearward flow of air shown by arrows 120. In FIG. 7, facemask section 201 is shown. In some embodiments, facemask section 201 has elastic properties to conform to the face.

In at least some embodiments, sections of mask assembly 100 are coated with silicone, rubber, and/or other comfort inducing materials. In at least some embodiments, these materials can help a user wear a mask for long period without discomfort and/or worrying about transmission/reception of infections.

In some embodiments, parts of mask assembly 100 can be boiled and/or autoclaved and is reusable. In some embodiments, the entire mask assembly 100 can be boiled and/or autoclaved and is reusable. In some embodiments, mask assembly 100 can be cleaned by chemical disinfectant methods. In some embodiments, pleated filter 111 can be boiled and/or autoclaved. In some embodiments, strap 102 can be boiled and/or autoclaved. In certain embodiments, strap 102 does not need to be disassembled from mask 101 before being boiled and/or autoclaved. In some embodiments, mask assembly 100 can be cleaned and/or boiled without disassembling it. In some embodiments, pleated filter 111 is disposable.

In at least some embodiments, a pleated filter interacts with a series of vents. In at least some of such embodiments, mask assembly 100 offers double the inhalation venting and triple the exhalation venting of a comparable dual canister filter mask.

In at least some embodiments, a mask system allows for particles exhaled by a wearer to strike a pleated filter at an oblique angle. In some embodiments, to the event that a wearer coughs or sneezes, thus inducing a high-pressure zone preceding the filter in the mask, the filter captures particles and vents air backwards away from individuals the wearer may be facing or interacting with.

In at least some embodiments, inhalation and exhalation pressures are inherently close to identical within mask system 100. At least some such embodiments offer advantages such as retarding the migration of particulates and pathogens through a filter system.

Particular elements (such as, but not limited to, the chin strap structure, the nose bridge clip and the like) can be incorporated into facemask assemblies in other suitable combinations or arrangements, for example to suit particular applications.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A mask assembly comprising:
(a) a single continuous strap;
(b) a first snap-in receiver near a nasal area;
(c) a second snap-in receiver near a chin area;
(d) an at least one vent;
(e) a facial skirt; and
(f) a front section;
wherein said single continuous strap is configured to interact with said first snap-in receiver and said second snap-in receiver.

2. The mask assembly of claim 1 wherein said continuous strap is configured to be twisted to tighten said mask assembly on a face.

3. The mask assembly of claim 1 wherein said continuous strap is configured to self-align in said first snap-in receiver and said second snap-in receiver.

4. A mask assembly comprising:
(a) a continuous strap;
(b) a first snap-in receiver near a nasal area;
(c) a second snap-in receiver near a chin area;
(d) a facial skirt; and
(e) a front section;
(f) a first vent configured to vent exhaled CO₂ backwards and towards a wearer's face; and
(g) a second vent configured to create oblique airflow patterns over a filter insert when said wearer inhales.

5. The mask assembly of claim 4 further comprising:
(h) a third vent, wherein said first vent and said third vent are arranged symmetrically around a mask.

6. The mask assembly of claim 4 further comprising:
(h) a filter insert assembly comprising:
(i) a rear frame;
(ii) a front frame; and
(iii) a filter material.

7. The mask assembly of claim 6 wherein said filter insert assembly is S-shaped.

8. The mask assembly of claim 6, wherein said filter material is flat.

9. The mask assembly of claim 6 wherein said mask assembly is configured to be disinfected via boiling.

10. The mask assembly of claim 6 wherein said mask assembly is configured to be autoclaved.

11. The mask assembly of claim 6 wherein said filter material comprises at least one active filter layer.

12. The mask assembly of claim 6, wherein said rear frame and said front frame are configured to cause said filter material to take on a pleated configuration when said filter material is placed between said rear frame and said front frame.

13. The mask assembly of claim 12 wherein said continuous strap is configured to be twisted to tighten said mask assembly on a face.

14. The mask assembly of claim 13 wherein said single continuous strap is configured to interact with said first snap-in receiver and said second snap-in receiver, and wherein said continuous strap is configured to self-align in said first snap-in receiver and said second snap-in receiver.

15. The mask assembly of claim 11 wherein said at least one active filter layer comprises silver nanoparticles.

16. The mask assembly of claim 6 wherein said front frame comprises at least one front-frame cross member and wherein said rear frame comprises at least one rear-frame cross member.

17. The mask assembly of claim 16 wherein said rear-frame cross member is elevated and curved to cause said filter material to assume a pleated shape.

18. The mask assembly of claim 17 wherein said pleated shape assumed be said filter material placed between said front frame and said rear frame results in a 10% more surface area of said filter material between said rear frame and said front frame when compared with an unpleated filter material placed between said front frame and said rear frame.

19. The mask assembly of claim 17 wherein said pleated shape assumed be said filter material placed between said front frame and said rear frame results in a 60% more surface area of said filter material between said rear frame and said front frame when compared with an unpleated filter material placed between said front frame and said rear frame.

20. A mask assembly comprising:
(a) a continuous strap configured to be twisted to tighten said mask assembly on a face;
(b) a first snap-in receiver near a nasal area;
(c) a second snap-in receiver near a chin area;
(d) a facial skirt; and
(e) a front section;
(f) a first vent configured to vent exhaled CO₂ backwards and towards a wearer's face;
(g) a second vent configured to create oblique airflow patterns over a filter insert when said wearer inhales;
(h) a third vent, wherein said first vent and said third vent are arranged symmetrically around a mask;
(i) an S-shaped filter insert assembly comprising:
(i) a rear frame comprising at least one rear-frame cross member, wherein said rear-frame cross member is elevated and curved;
(ii) a front frame comprising at least one front-frame cross member; and
(iii) a filter material, wherein said filter material comprises at least one active layer and wherein said at least on active layer comprises silver;
wherein said rear frame and said front frame are configured to cause said filter material to take on a pleated configuration when said filter material is placed between said rear frame and said front frame.
